(19) United States
(12) Patent Application Publication
(10) Pub. No.: US 2026/0339048 A1
(43) Pub. Date: Oct. 29, 2026

(54) OPTICAL DEVICES AND METHODS OF MANUFACTURE

(71) Applicant: Taiwan semiconductor Manufacturing Co., Ltd., Hsinchu (TW)

(72) Inventors: Zi-Jheng Liu, Taoyuan City (TW); Chiahung Liu, Hsinchu (TW); Ming-Fa Chen, Taichung City (TW)

(21) Appl. No.: 19/733,371

(22) Filed: Jul. 7, 2026

Related U.S. Application Data
(63) Continuation of application No. 18/945,128, filed on Nov. 12, 2024.

(51) Int. Cl. G02B 6/42

(52) U.S. Cl. CPC G02B 6/4239

(57) ABSTRACT

A method of manufacturing an optical device that can include forming a plurality of first metal structures on a first region of a base surface of a die and a second metal structure on a second region of the base surface of the die, wherein the second metal structure has a different shape compared to the at least the first metal structure, and the second metal structure has a bar-type shape. The method can further include bonding the die to a supporting substrate through the plurality of the first metal structures, and applying an underfill material between the base surface of the die and the supporting substrate. In some embodiments, in a cross-sectional view, the underfill material extends from a top surface of the supporting substrate to a sidewall of the die.

### CROSS-REFERENCE TO RELATED APPLICATIONS

This application is a continuation of U.S. Application No. 18/945,128, filed on Nov. 12, 2024, which applications are hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-8 illustrate formation of an optical package including an edge coupler, in accordance with some embodiments;

FIG. 9 illustrates forming connection bumps, such as C4 solder bumps, and an edge dam on the base of the optical package, in accordance with some embodiments;

FIG. 10 illustrates the geometry of a connection bump array, such as an array of C4 solder bumps, a geometry for an edge dam, and positioning of a polymeric layer on a base surface of the optical package, in accordance with some embodiments;

FIG. 11 illustrates positioning of the optical package including connection bumps and the edge dam above a supporting substrate prior to bonding, in accordance with some embodiments;

FIG. 12 illustrates bonding the optical package to the supporting substrate through connection bonds provided by the connection bumps, in accordance with some embodiments;

FIG. 13 illustrates applying an underfill to the space between the supporting substrate and the optical package, wherein an edge dam obstructs the underfill from reaching a side of the package at which an edge coupler interfaces with a fiber array unit (FAU), in accordance with some embodiments; and

FIG. 14 illustrates connecting the fiber array unit (FAU) to interface with the edge coupler of the optical package, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which an edge dam structure is used to control the application of underfill materials between optical packages and supporting substrates that are bonded together. The coefficient of thermal expansion (CTE) of an optical package can be different from the coefficient of thermal expansion (CTE) for the supporting substrate that the optical package is bonded to. In some instances, due to the difference in coefficients of thermal expansion, because the optical package and the supporting substrate are connected by underfill, mechanical forces can be induced between the optical package and the supporting substrate when one of the structures experiences thermal temperature induced dimensional changes. This can cause warpage in one or both of the supporting substrate and the optical package. It has been determined that by removing the underfill from the region of the device at which the edge coupler is connected to the fiber array unit (FUA), some of the negative effects of device warpage can be minimized.

The embodiments presented, however, are intended to be illustrative and are not intended to limit the ideas presented to the precise embodiments described. Rather, the ideas presented may be incorporated into a wide variety of embodiments, and all such embodiments may be included within the overall scope of the disclosure.

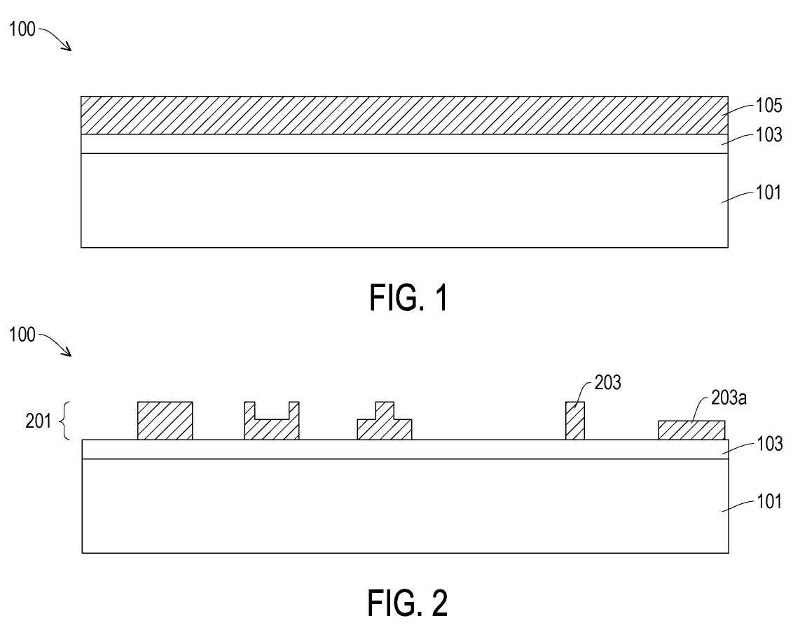

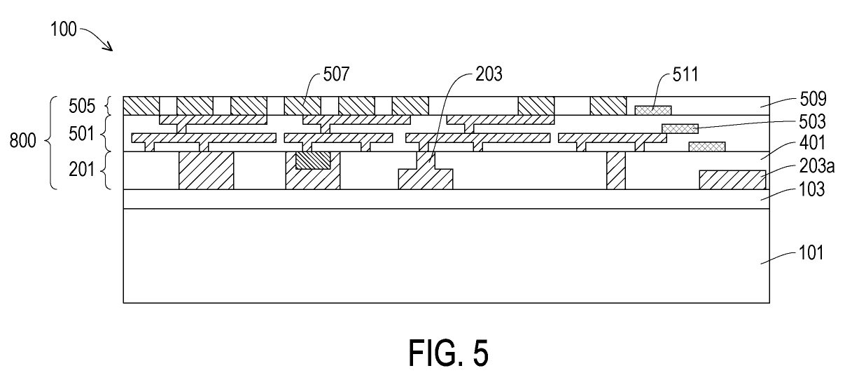

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

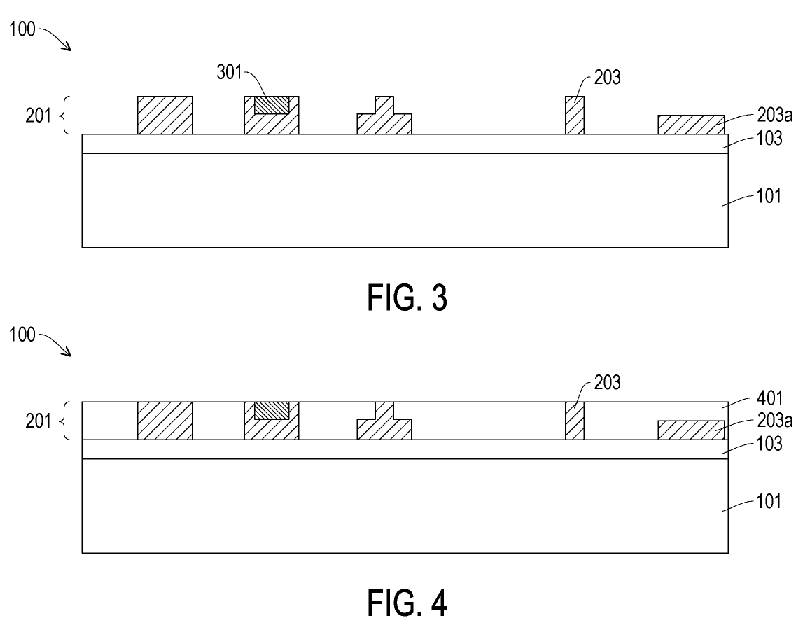

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

In an embodiment, the first optical components 203 include one or more edge couplers 203a. An edge coupler 203a may also be referred to as butt coupling, under which an optical fiber is horizontally aligned with the edge coupler 203a that leads into the waveguides. Edge couplers 203a can achieve high coupling efficiency, broad bandwidth, and polarization independence. In some embodiments, fiber-to-chip edge couplers may include an inverse taper structure. In some embodiments, corresponding to the direction of light propagation, the inverse taper refers to a tapering waveguide with a gradual increase in width along the mode propagation direction, which means the narrow end of the taper is close to fiber, while the wide end is connected with photonic waveguides.

Modal distribution is determined by both the mode order and the waveguide structure. For a specific mode, waveguides with a certain cross-section area can support the entire mode. The fundamental transverse electric (TE) mode is mostly applied in optical communication applications to transmit information. In some embodiments, the size of silicon photonic waveguide is selected to support the fundamental TE mode propagation at negligible loss. For example, the waveguide can have dimensions of about 200 nanometers high and about 500 nanometers wide. A waveguide with a too small cross-section area cannot support an entire fundamental mode, and thus the mode will partially distribute in the outer region of the waveguide. In contrast, a waveguide with a too large cross-section area will easily excite undesirable higher-order modes. A taper can be appropriate for mode conversion, since a gradually varying cross-section area supports mode transformation and mode size variation.

In some embodiments, the narrow end of the inverse taper for the edge coupler 203a can have a smaller cross-section area than the expected modal size, so it is unable to confine the incident mode completely, and a considerable percentage of the electromagnetic field distributes surrounding the taper tip. As the taper width becomes larger, it can support the entire mode and confine the electromagnetic field inside the taper integrally. Overall, in some embodiments, an edge coupler 203a based on an inverse taper whose narrow tip is aligned to the fiber core can convert a large mode incident from the optical fiber to the compressed guided mode in photonic waveguides.

In some embodiments, the basic structure of an edge coupler, such as the edge coupler 203a depicted in FIG. 3, is based on a single inverse taper that can convert the mode within a length of several hundred microns. In some embodiments, the taper may have a linear profile. Common transformations of linear tapers include multi-sectional tapers, parabolic tapers or quadratic tapers, and exponential inverse tapers.

In some embodiments, at least the tip of the edge coupler 203a may be composed of silicon nitride (SiN). In some embodiments, an edge coupler 203a composed of silicon nitride (SiN) may be formed on the same level as the first optical components 203 that are composed of the material 105 for the first active layer 201, which in some examples is silicon (Si). To provide an edge coupler 203a composed of different composition material from the other first optical components 203, a protective mask may first be formed protecting the other first optical components 203. Thereafter, an etch process may be performed to remove the material 105 for the first active layer 201 from the region that the edge coupler 203a is to be formed in. In a following process sequence, the material for the edge coupler 203a may then be formed and patterned to provide the edge coupler 203a, which may include at least a silicon nitride (SiN) tip.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

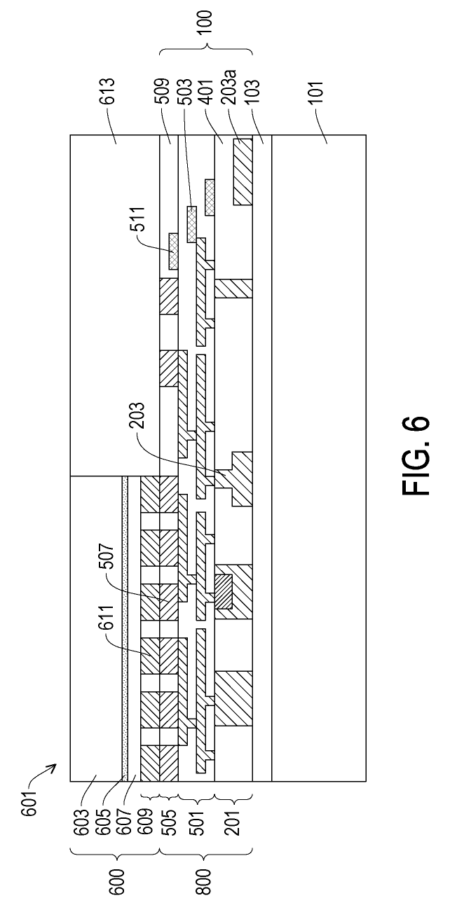

FIG. 5 illustrates that, once the first optical components 203 of the first active layer 201, as well as the edge coupler 203a, have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment, the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

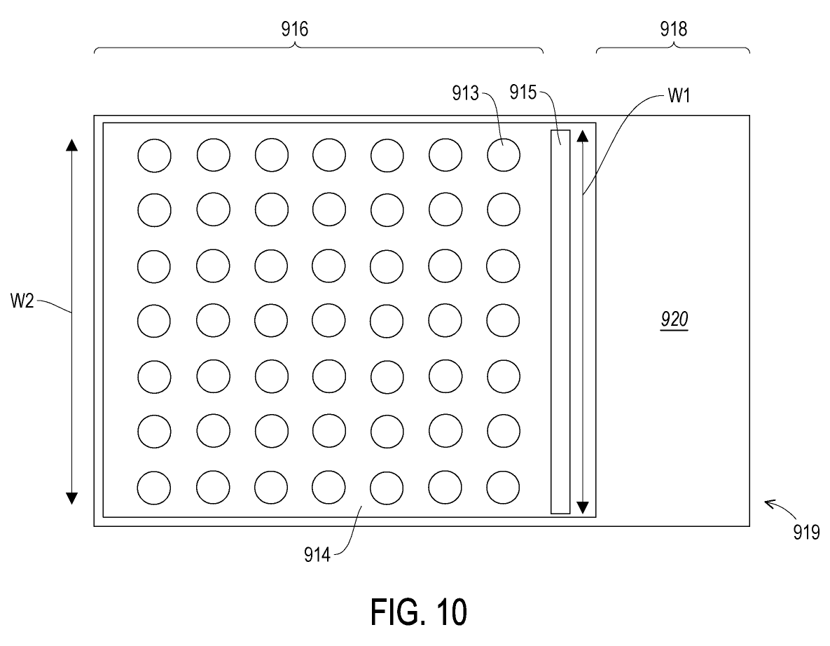

The elements depicted in FIG. 5 may provide a photonic integrated circuit (PIC) 800. The photonic integrated circuit (PIC) 800 is an electrical component that contains photonic components, which are components that work with light (photons). The photonic integrated circuit (PIC) 800 depicted in FIGS. 10-14 includes less detail than depicted in FIG. 5, which is only intended to simplify the figures for discussion of other elements of the disclosure. It is not intended that the elements from the PIC circuit 800 described above, but not depicted in FIGS. 10-14, are omitted from their presence.

FIG. 6 illustrates a bonding of a first semiconductor device 601 to the first bonding layer 505 of the optical interposer 100. In some embodiments, the first semiconductor device 601 is an electronic integrated circuit 600 (EIC – e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the laser die. For example, the optical interposer 100 and the first semiconductor device 601 may be subjected to a pressure of about 200 kPa or less, and a temperature between about 25°C and about 250°C to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150°C and about 650°C, to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 (in some embodiments referred to as oxide containing fill material) is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

The electronic integrated circuit (EIC) 600 depicted in FIGS. 10-14 includes less detail than depicted in FIG. 6, which is only intended to simplify the figures for discussion of other elements of the disclosure. It is not intended that the elements from the EIC circuit 600 described above, but not depicted in FIGS. 10-14, are omitted from their presence.

The photonic integrated circuits (PIC) 800 and the first semiconductor device 601 that provides the electronic integrated circuit (EIC) 600 can be elements of a compact universal photonic engine (COUPE) chip. COUPE uses light instead of electricity to perform communication, allowing for faster data transfer and reduced energy consumption compared to traditional electronic-based systems. In some embodiments, COUPE chips can combine an electronic integrated circuit (EIC) 600 with a photonic integrated circuit (PIC) 800 using system on integrated chip (SoIC) packaging technology. SoIC includes 3D inter-chip (3D IC) stacking technologies for integration of chiplets partitioned from System on Chip (SoC) and System on technology, such as dielectric-to-dielectric and metal-to-metal bonding processes. Photonic integrated circuits (PIC) 800 are designed to harness the unique properties of light, offering advantages such as high bandwidth, low power consumption, and faster data transfer speeds compared to their electronic counterparts. These circuits often include components, such as waveguides, couplers, lasers, light emitting diodes (or other sources of coherent light), modulators, detectors, and other optical elements, such as mirrors and reflectors. However, any suitable components may be utilized. In comparison, the first semiconductor device 601 that provides the electronic integrated circuit (EIC) 600 uses only electronic devices, like transistors and capacitors, on a single chip. In some embodiments, COUPE (Compact Universal Photonic Engine) can provide performance enhancements in HPC (High-Performance Computing) application by enabling faster processing of large amounts of data. COUPE uses light instead of electricity to perform communication, allowing for faster data transfer and reduced energy consumption compared to traditional electronic-based systems.

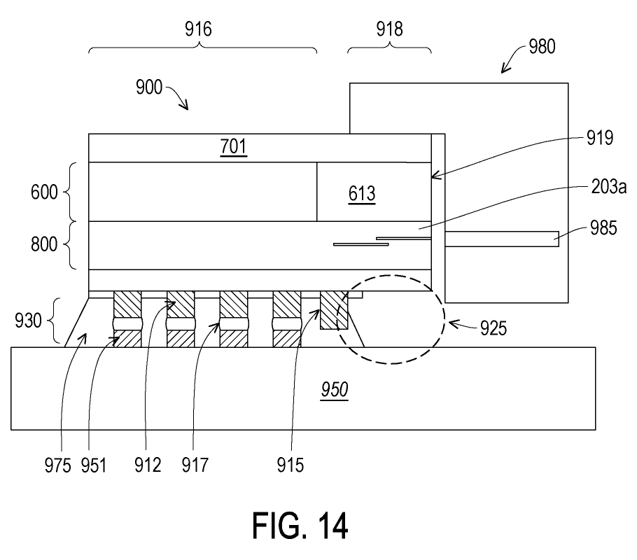

By having the edge coupler 203a in the COUPE chip, the edge coupler 203a can provide broader bandwidth and higher coupling efficiency than a grating coupler (GC). In some embodiments, the edge coupler 203a is a desirable approach to meet optical input/output (I/O) roadmaps with the COUPE chip arrangement provided with the photonic integrated circuits (PIC) 800 and the first semiconductor device 601 that provides the electronic integrated circuit (EIC). Minimizing warpage of the optical package 900 and the supporting substrate 950 is a challenge for achieving optimum alignment of the FAU (fiber array unit) 980 (depicted in FIG. 14) with the SiN tip of the edge coupler 203a for providing high coupling efficiency and low insertion loss. The optical package 900 may also be referred to as a die. Further, the die structure of the optical package may include an e-die structure (also referred to as electronic integrated circuit 600) that includes active devise, and a p-die structure (also referred to as photonic integrated circuit (PIC) 800) that includes a waveguide.

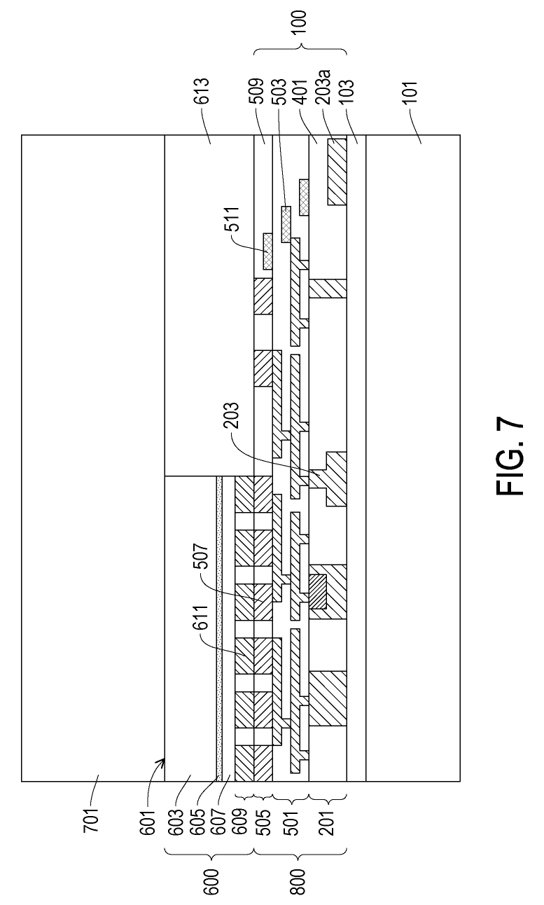

FIG. 7 illustrates an attachment of a semiconductor substrate 701 (in some embodiments referred to as a silicon substrate) to the first semiconductor device 601 and the first gap-fill material 613. In an embodiment the semiconductor substrate 701 may be a support material that is transparent to the wavelength of light that is desired to be used, such as silicon, and may be attached using, e.g., an adhesive (not separately illustrated in FIG. 7). However, in other embodiments the semiconductor substrate 701 may be bonded to the first semiconductor device 601 and the first gap-fill material 613 using, e.g., a bonding process. Any suitable method of attaching the semiconductor substrate 701 may be used.

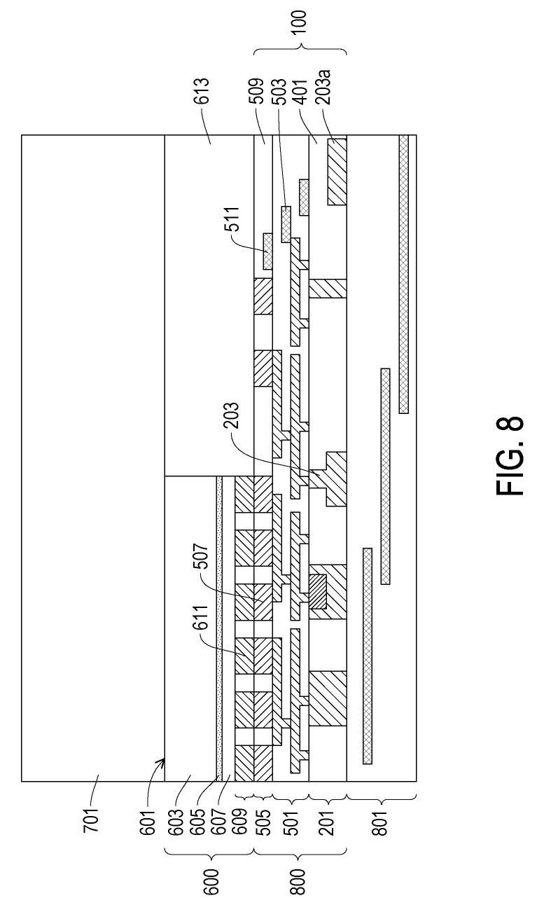

FIG. 8 illustrates a removal of the first substrate 101 and, optionally, the first insulator layer 103, thereby exposing the first active layer 201 of first optical components 203, as well as the edge coupler 203a. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

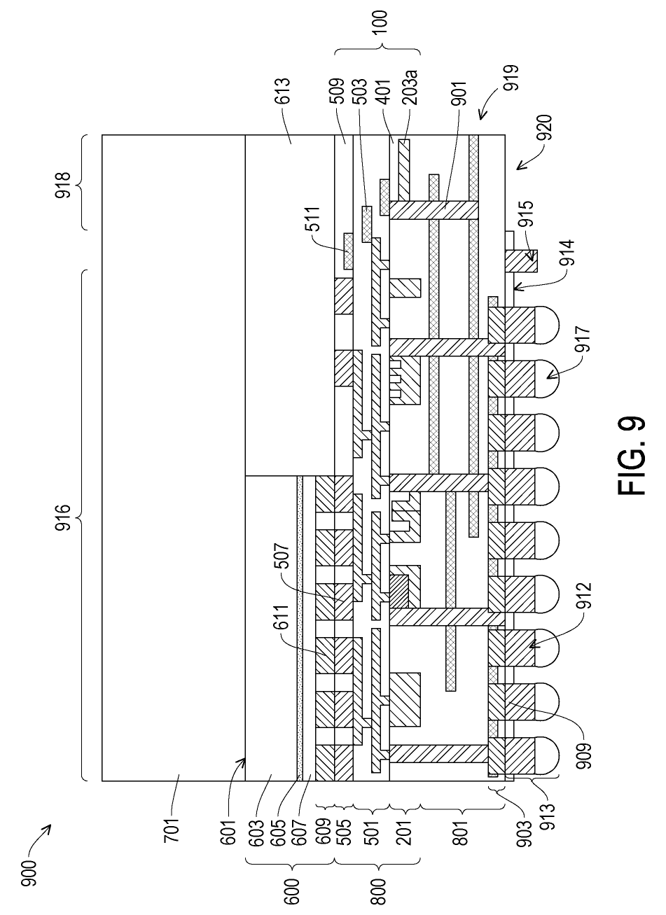

FIG. 9 illustrates formation of first through device vias (TDVs) 901 and formation of a third bonding layer 903 to form an optical package 900. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

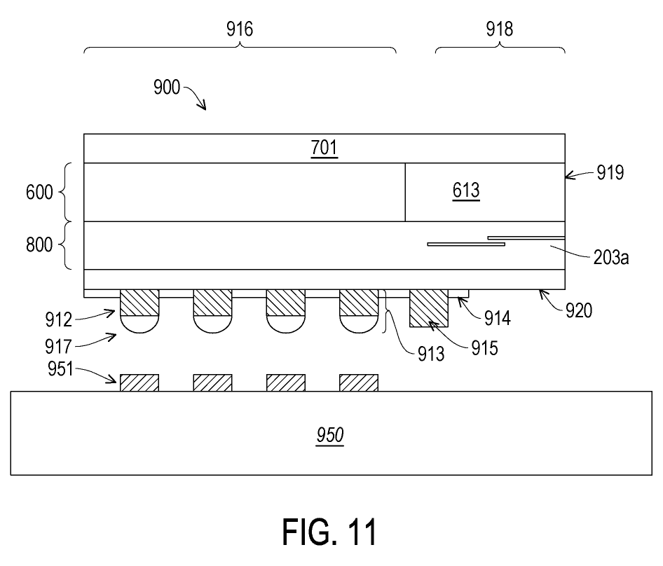

FIG. 9 illustrates an embodiment of forming the connection bumps 913, such as C4 solder bumps, and an edge dam 915 on the base of the optical package 900. The connection bumps 913 can provide conductive regions for contact between the third bond pads 909 to other external devices, such as a supporting substrate 950 (as depicted in FIGS. 11-14). In some embodiments, the connection bumps 913 provide the plurality of connections between the optical package 900 and the supporting substrate 950. The connection bumps 913 may be conductive bumps (e.g., C4 bumps, ball grid arrays, microbumps, etc.) or conductive pillars utilizing materials such as solder and copper. In an embodiment in which the connections bumps 913 are contact bumps, the connection bumps 913 may include a material such as tin, or other suitable materials, such as silver, lead-free tin, or copper.

One example process sequence for forming the connection bumps 913 can begin with forming a polymeric layer 914 on the base of the optical package 900. In some embodiments, the polymeric layer 914 may be a polyimide or other type of insulative material. For example, the polymeric layer 914 may be an organic polyimide film, e.g., a photosensitive polyimide film. Polyimide (sometimes abbreviated PI) is a polymer containing imide groups. One example polyimide can be produced by condensation of pyromellitic dianhydride and 4,4'-oxydianiline.

In some embodiments, prior to forming the polymeric layer 914, an electrically conducting barrier layer (not shown) may be formed on the contacts, e.g., third bond pads 909. In some embodiments, the electrically conducting battier layer is suitable for adhesion to the passivation layer and to form the bond to the solder bumps. Depending on the choice of the bumping process, the layer may be deposited locally as in evaporated bumps, or it may be a continuous film. In some embodiments, the layer is also known as the ball-limiting metallurgy (BLM) and under bump metallurgy (UBM). It is noted that the electrically conducting barrier layer may be omitted.

In some examples, the polymeric layer 914, e.g., photosensitive polyimide, can be deposited on the third bonding layer 903 (as well as the optional electrically conductive battier layer) having the third bond pads 909. The polymeric layer 914 can be deposited using a deposition method such as, for example, spin-on deposition. In embodiments, the polymeric layer 914 can range in thickness from about 5 to 10 microns in height; although other dimensions are also contemplated by the invention.

In some embodiments, in which the polymeric layer 914 is composed of a photosensitive polyimide, the material is exposed and developed to form vias corresponding to the third bond pads 909. The via openings may be configured in an array of via openings on a first side 916 of the optical package 900. The via openings are subsequently filled with the connection bumps 913. The connection bumps 913 provide for connection between the optical package 900 and the supporting substrate 950, as depicted in FIGS. 10 and 11.

Referring to FIG. 9, in some embodiments, the polymeric layer 914 may also be patterned and developed to remove a portion of the polymeric layer 914, e.g., photosensitive polyimide layer, from a second side 918 of the optical package 900. The second side 918 of the optical package 900 provides the location for engagement of the fiber array unit (FAU) 980, which is later described with reference to FIG. 14. It has been determined, that in some examples, the polymeric layer 914 may shrink. Shrinkage of the polymeric layer 914 while attached to the base surface of the optical package 900 can induce a stress on the optical package 900 that can cause it to warp. Warpage of the optical package 900 is one factor that impacts the alignment of the edge coupler 203a that is integrated into the optical package 900 with the optical fibers of the later connected fiber array unit (FAU), in which misalignment of the fiber array unit (FAU) can result in insertion loss. It has been determined that removing the polymeric layer 914 from the second side 918 of the optical package 900 can reduce the aforementioned stresses that are induced from the polymeric layer 914 to the second side 918 of the optical package 900.

In some embodiments, the polymeric layer 914 may also be patterned and developed to form a trench that is later filled to provide an edge dam 915. In some embodiments, the trenches may have a rectangular geometry that extends across an entire width of the array of via openings. The width of the trench for the edge dam 915 is selected to continuously extend across the width of the region of the optical package 900 in which the connection bumps 913 are present. The edge dam 915 is to be formed in the trench patterned into the polymeric layer 914. The pattern for forming the trench into the polymeric layer 914 that defines the positioning of the edge dam 915 may also remove the polymeric layer 914 from the backside surface 920 of the optical package 900. However, a portion of the polymeric layer 914 may remain in the second side 918 of the optical package proximate to the outside sidewall of the edge dam 915.

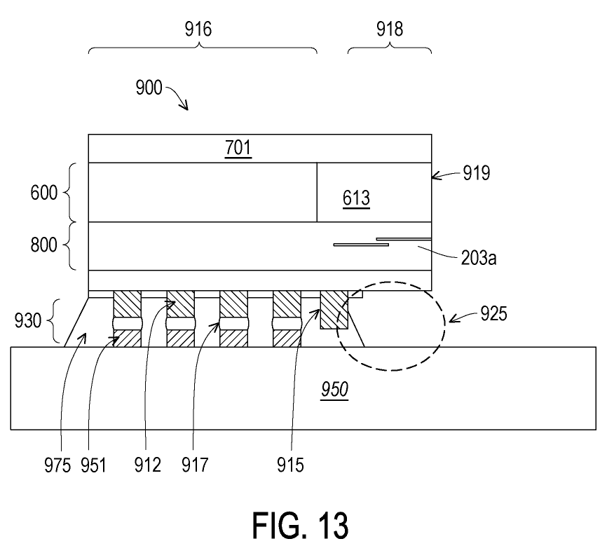

The edge dam 915 is positioned to keep subsequently placed underfill 975 that is applied to fill the space between the first side 916 of the optical package 900 and the supporting substrate 950 from reaching the second side 918 of the optical package 900, as described below with reference to FIG. 13. It has been determined that the underfill 975 when present between the substrate 950 (the substrate is depicted in FIGS. 10 and 11) and the optical package 900 can induce mechanical stresses that result from differences in the thermal expansion coefficients (TECs) of the substrate 950 and the optical package 900. These mechanical stresses that result from differences in thermal expansion between the optical package 900 and the substrate 950 can cause warpage in the optical package 900. Warpage at the second side 918 of the optical package 900 can negatively impact alignment of the edge coupler 203a in the optical package 900 to the optical fiber 985 of the fiber array unit (FAU) 980, as depicted in FIG. 14. By removing the underfill from filling the space between the substrate 950 and the optical package 900 at the second side 918 of the optical package 900, the warpage effects resulting from differences in thermal expansion coefficients (TECs) of the optical package 900 and the substrate 950 can be eliminated or at least minimized.

It is noted that the patterning of the via openings for the connection bumps 913, the trench for the edge dam 915 and removing the polymeric layer 914 from the second side 918 of the optical package 900 may be performed using the same photolithography pattern. However, other embodiments have been contemplated, in which a separate mask is employed for patterning at least one of the via openings for the connection bumps 913, the trench for the edge dam 915 and removing the polymeric layer 914 from the second side 918 of the optical package 900.

FIG. 9 illustrates forming the connection bumps 913 and the edge dam 915. The connection bumps 913 may be formed using a plating process, a bumping process or a combination of plating and bumping processes. In some embodiments, the connection bumps 913 may include solder bumps, such as C4 solder bumps, or the connection bumps 913 may include a copper pillar 912. In some embodiments, the connection bumps 913 may include a copper pillar 912 in combination with a solder cap 917. Although FIGS. 9-14 illustrate a connection bump 913 including a copper pillar 912 and a solder cap 917, the copper pillar 912 may be omitted, and the solder element may be formed on the third bond pad 909 as a C4 solder bump.

In the embodiments, in which the connection bumps 913 are solder bumps, such as C4 solder bumps, the layer of material for the connection bumps 913 may be deposited locally as in evaporated bumps, or it may be a continuous film, as required in electroplating for passage of electric current through the wafer. The solder bumps may be composed of tin-solder. In some embodiments, when a barrier layer, such as ball limiting metallurgy (BLM layer) is present, the size and shape of a connection bump 913 after reflowing is determined by the size of the barrier layer under the bump.

In some embodiments, in which the connection bumps 913 are C4 solder bumps composed of tin solder bumps, the connection bumps 913 may be formed by initially forming a layer of tin on the third bond pads 909 through such commonly used methods such as evaporation, electroplating, printing (e.g., screen printing), solder transfer, ball placement, etc. Other methods include solder jetting and pick and place solder transfer process. After the bump fabrication step, the wafer is reflowed, that is, subjected to a thermal cycle in a protective environment to melt the solder bumps and form spherical balls.

Connection bumps 913 including the copper pillar 912 are an alternative to a connection bump 913 composed entirely of solder, such as the above described C4 solder bumps. The structure and fabrication production process of a pillar bump 913 including the copper pillar 912 can include the integration of a photolithography and electroplating processes. In some embodiments, a thin metal seed layer (not shown) can be sputtered onto the third bond pads 909. In some examples, the thin metal seed layer may include an adhesion layer, normally Ti or TiW, and a Cu seed layer serving as a conducting layer for plating. The thin metal seed layer may be formed before or after the processing of the polymeric layer 914, e.g., the deposition and patterning of the polymeric layer 914. In some embodiments, the thin metal seed layer may be omitted.

In some embodiments, the copper pillars 912 may be electroplated onto the third bond pads 909, e.g., onto the thin metal seed layer (if present) that is present on the third bond pads 909. In some examples, electroplating may include an electroplating bath composed of copper sulfate in sulfuric acid with copper chloride as an additive. Other additives are also added to the bath for improvement of deposit properties such as grain refinement and ductility. In some embodiments, these additives include thiourea, polyethylene glycol and surfactants. In some embodiments, pyrophosphate baths can be used for high-speed electrodeposition of copper (Cu). In some embodiments, a combination of the high-speed plating bath and pulsed current allows deposits of copper (Cu) with different morphologies at high speed of deposition at several microns (µm)/minute.

In some embodiments, a solder cap 917 can be formed on top of the copper pillar 912 and subsequently reflowed to form a solder bump or a cap. The solder cap 917 may include tin-solder, and may be formed using the above described solder bump methods.

In some embodiments, the connection bumps 913 may be arranged in an array on the first side 916 of the optical package 900. The array may include columns and rows of connection bumps 913.

FIG. 9 also depicts forming an edge dam 915 at the interface of the first side 916 and the second side 918 of the base surface of the optical package 900. In some embodiments, the edge dam 915 is positioned to define a keep out zone (KOZ) 925 (first depicted in FIG. 13) between the edge dam 915 and a wave guide connecting surface present at the sidewall 919 of the optical package 900. In some embodiments, the edge dam 915 is a metal pillar having a continuous width (as depicted in FIG. 10) that extends across and entirety of a width of an array of the connection bumps 913. In some examples, the metal composition for the edge dam 915 may be copper. However, other metal compositions may also be used for the edge dam, such as aluminum or tungsten.

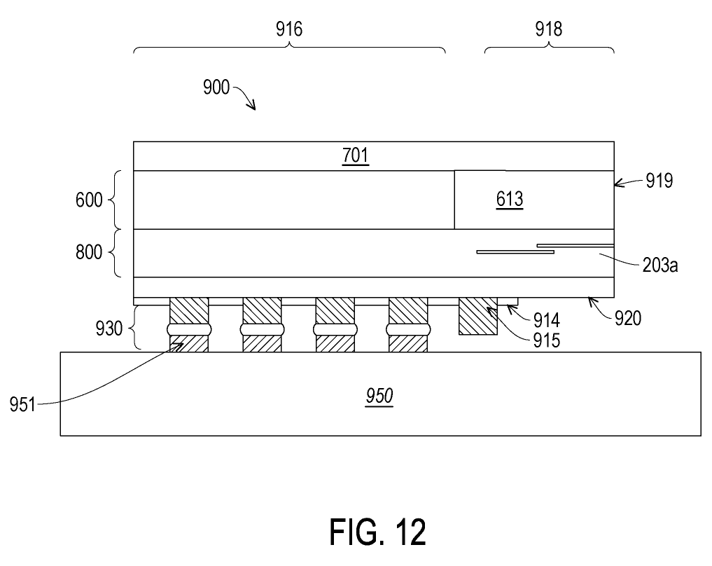

The edge dam 915 is deposited, e.g., by electroplating, in the trench that has been previously patterned into the polymeric layer 914. Similar to plating processes for forming elements of the connection bumps 913, such as the above described copper pillars 912, the deposition surfaces for the edge dam 915 may include a seed layer that has been formed prior to the plating process for forming the edge dam 915. In some examples, the thin metal seed layer may include an adhesion layer, normally Ti or TiW, and a Cu seed layer serving as a conducting layer for plating. The edge dam 915 may be formed using an electroplating process similar to the electroplating process that has been described for forming the copper pillars 912 described above for an element of the connection bumps 913. However, the edge dam 915 does not include a solder cap 917. The edge dam 915 may have a bar type geometry. The plating process is configured to provide an edge dam 915 having a height that is greater than the height of the polymeric layer 914. As will be further illustrated below, the edge dam 915 will not directly contact the supporting substrate 950. The height of the edge dam 915 is selected to extend towards the supporting substrate 950, but not contact the supporting substrate 950 when the supporting substrate 950 and the optical package 900 are bonded to one another, as depicted in FIG. 12. This provides that the edge dam 915 will be an obstruction, e.g., dam, towards keeping the underfill 975 that is applied to the first side 916 of the optical package 900 from extending into the second side 918 of the optical package 900 to an extent that it will fill the space between the optical package 900 and the supporting substrate 950 in the second side 918, as will further be described in FIG. 13.

In some embodiments, the edge dam 915 and the connection bumps 913 may be formed using the same process sequences. In some embodiments, the edge dam 915 and the connection bumps 913 may be formed using different process sequences. In the embodiments, in which the edge dam 915 and the connection bumps 913 are formed using different process sequences, block masks, e.g., photoresist masks, may be used to individually process the regions of the optical package 900 in which the connection bumps 913 and the edge dam 915 may be formed.

FIG. 10 is a bottom up view of the side-cross sectional view for the structure depicted in FIG. 9. FIG. 10 further illustrates the polymeric layer 914 being present at the first side 916 of the optical package 900, but is removed from the second side 918 of the optical package 900. The second side of the optical package 900 includes the sidewall 919 of the optical package 900 at which a fiber array unit (FAU) will be subsequently attached, as depicted in FIG. 14. The polymeric layer 914 can shrink, and have a different coefficient of expansion from the optical package 900. The changes in dimensions between the polymeric layer 914 and the optical package 900 can result in the generation of mechanical stresses that can warp the optical package 900. Warping the optical package 900 can impact alignment of the optical fiber of a fiber array unit to the edge coupler 203a of the optical package 900, which disadvantageously results in insertion loss. Removing the polymeric layer 914 from the second side 918 of the optical package 900 produces an exposed backside surface 920 of the optical package 900 in the second side 918 of the optical package 900. By removing the polymeric layer 914 from the second side 918 of the optical package 900, the mechanical stresses that result from polymeric shrinkage can be removed from the portion of the optical package 900 that interfaces with the fiber array unit (FAU) 980 will be subsequently attached, as depicted in FIG. 14. Avoiding warping the optical package 900 at the side of the optical package 900 that interfaces with the fiber array unit (FAU) advantageously minimizes insertion loss.

FIG. 10 also illustrates the geometry of an array of connection bumps 913 and the geometry for the edge dam 915. The connection bumps 913 are only present on the first side 916 of the optical package 900. The second side 918 of the optical package 900 does not include connection bumps 913. Removing the connection bumps 913 from the second side 918 of the optical package 900 is another mechanism through which warpage at the edge of the optical package 900 is minimized. The array of connection bumps 913 may include columns and rows of connection bumps 913 providing a four sided geometry, such as being rectangular. The pitch of the connection bumps 913 may be equal to 150 microns. The width W1 of the edge dam 915 is selected to continuously extend across the width W2 of the array of connection bumps 913. The edge dam 915 is positioned to keep subsequently formed underfill 975 that is applied to fill the space between the first side 916 of the optical package 900 and the supporting substrate 950 from filling the second side 918 of the optical package 900, as will be described in greater detail below with reference to FIG. 13.

FIGS. 11 and 12 illustrate that after the formation of the connection bumps 913 and the edge dam 915, the optical package 900 may be bonded to the supporting substrate 950. FIG. 11 illustrates positioning of the optical package 900 including connection bumps 913 and the edge dam 915 above the supporting substrate 950 prior to bonding. FIG. 12 illustrates bonding the optical package 900 to the supporting substrate 950 through connection bonds 930, e.g., solder bonds, provided by the connection bumps 913.

The supporting substrate 950 may be used to couple the optical package 900 with other devices to form, for example, a chip-on-wafer-on-substrate (CoWoS^{®}) device. The supporting substrate 950 may be a printed circuit board (PCB). The supporting substrate 950 may include a plurality of substrate contact pads 951. The supporting substrate 950 may also comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, active devices (not separately illustrated) may be added to the supporting substrate 950. The active devices can include a wide variety of active devices and passive devices such as capacitors, resistors, inductors and the like that may be used to generate the desired structural and functional requirements of the design for the supporting substrate 950. The active devices may be formed using any suitable methods either within or else on the supporting substrate 950.

In some embodiments, bonding between the optical package 900 and the supporting substrate 950 may include aligning the solder elements, e.g., solder caps 917, of the connection bumps 913 that are connected to the optical package 900 to the substrate contact pads 951 of the supporting substrate 950, as depicted in FIG. 11.

Following alignment, the connection bumps 913 may be contacted to the substrate contact pads 951 under temperature and pressure to effectuate bonding there between through connection bonds 930. In some embodiments, the solder from the solder caps 917 provide for a bond between the copper pillar 912 and the substrate contact pads 951 using, e.g., a reflow process. For example, the optical package 900 and the supporting substrate 950 may be subjected to a pressure of about 200 kPa or less, and a temperature between about 25°C and about 250°C to fuse the optical package 900 to the supporting substrate 950 through the connection bonds 930. In some embodiments, the optical package 900 and the supporting substrate 950 may then be subsequently baked, annealed, pressed, or otherwise treated to strengthen or finalize the bond. In some embodiments, the solder caps 917 may be omitted. In some embodiments, bonding between two copper pillar structures may be provided by thermal compression bonding (TCB).

Following bonding of the optical package 900 to the supporting substrate 950, a space is present between the base surface of the optical package 900 and the upper surface of the supporting substrate 950. Following bonding, the edge dam 915 extends in a direction from the base surface of the optical package 900 towards the upper surface of the supporting substrate 950, but the edge dam 915 is separated from, e.g., does not directly contact, an upper surface of the supporting substrate 950.

FIG. 13 illustrates an embodiment of applying an underfill 975 to the space between the supporting substrate 950 and the optical package 900, wherein the edge dam 915 obstructs the underfill 975 from filling the side of the package, e.g., the second side 918, at which the edge coupler 203a interfaces with an optical fiber 985 of the fiber array unit (FAU) 980. The underfill 975 may be a thermoset epoxy or polymer that is applied to the connection bonds 930 to protect them and strengthen solder joints. The underfill 975 may flow using capillary action and can be heated to cure.

The underfill 975 may be first introduced from the first side 916 of the optical package 900 and fills the space between the base surface of the optical package 900, the connection bonds 930 and the upper surface of the supporting substrate 950. The underfill 975 extends across the entire width of the first side 916 coming into contact with the edge dam 915. The edge dam 915 obstructs the underfill 975 from flowing significantly into the space between the optical package 900 and the supporting substrate 950 on the second side 918 of the optical package 900 in an amount that would fill the space on the second side 918. In some embodiments, the underfill 975 can fill the entirety of the space between the optical package 900, the supporting substrate 950 and the connection bonds 930. In some embodiments, after filling the space in the first side 916, the underfill 975 can extend up the first sidewall of the optical package 900. However, the underfill 975 is not present at the second side 918, and does not extend up the second sidewall of the optical package.

By obstructing the underfill 975 from filling the space on the second side 918 of the optical package 900, the edge dam 915 forms a keep out zone (KOZ) 925 at the second side 918 of the optical package 900. The keep out zone (KOZ) 925 is a space, e.g., an air filled void, that is present between the base of the optical package 900 and the upper surface of the supporting substrate 950. More particularly, the underfill 975 material fills the space from the first side 916 of the optical package 900 to the edge dam 915, but does not fill the keep out zone (KOZ) 925. In some embodiments, the space of the keep out zone (KOZ) 925 extends from the edge dam 915 to a sidewall 919 of the optical package 900 at which the fiber array unit (FAU) is subsequently connected, as depicted in FIG. 14. In some embodiments, the length of the keep out zone (KOZ) 925 may range from 100 microns to 5000 microns.

In some embodiments, by forming the keep out zone (KOZ) 925 at the second side 918 of the optical package 900, e.g., by keeping underfill material 795 from filling the space between the supporting substrate 950 and the optical package 900 at the second side of 918, the methods and structures described herein can avoid warpage of the optical package 900 that results from differences in the coefficient of thermal expansion (CTE) between the supporting substrate 950 and the optical package 900. The coefficient of thermal expansion (CTE) of an optical package 900 can be different from the coefficient of thermal expansion (CTE) for the supporting substrate 950 that the optical package 900 is bonded to. In some instances, due to the difference in coefficients of thermal expansion, mechanical forces can be induced between the optical package 900 and the supporting substrate 950 when one of the structures experiences thermal temperature induced dimensional changes. This can cause warpage in one or both of the supporting substrate 950 and the optical package 900. It has been determined that by removing the underfill 975 from the region of the device at which the edge coupler 203a is connected to the optical fibers, e.g., by forming the keep out zone (KOZ) 925 on the second side 918 of the optical package 900, some of the negative effects of device warpage can be minimized. For example, it has been determined that warpage of the optical package 900 can cause misalignment between the edge coupler 203a and the fiber array unit (FAU) 980. The methods and structures that remove at least the underfill 975 from the space between the optical package 900 and the supporting substrate 950 at the second side 918 of the optical package 900 minimizes or substantially eliminates misalignment between the edge coupler 203a and the fiber array unit (FU) 980. Therefore, the use of the edge dam 915 to obstruct the underfill 975 from filling the space between the optical package 900 and the supporting substrate 950 at the second side 918 of the optical package 900 can reduce or eliminate insertion loss that can result from warpage induced by differences in the thermal expansion coefficient (TEC) between the optical package 900 and the supporting substrate 950.

FIG. 14 illustrates connecting a fiber array unit (FAU) 980 to interface with the edge coupler 203a of the optical package 900. The fiber array unit (FAU) 980 abuts the sidewall 919 of the optical package 900 on the second side 918 of the optical package 900, in which the keep out zone (KOZ) 925 is present between the base surface of the optical package 900 and an upper surface of the supporting substrate 950. By obstructing the underfill 975 with the edge dam 915 from filling the space in the keep out zone (KOZ) 925 that is on the same size, e.g., second side 918, of the optical package 900 as the fiber array unit (FAU) 980, warpage is minimized to eliminate potential misalignment of the optical fiber 985 of the fiber array unit (FAU) 980 to the edge coupler 203a. By avoiding misalignment between the fiber array unit (FAU) 980 and the edge coupler 203a incidence loss of the signal transmitted between the optical fiber 985 and the edge coupler 203a is minimized and/or eliminated.

In some embodiments, one or more optical fibers 985 are signal coupled to the optical package 900 through the fiber array unit (FAU) 980. In some embodiments, the total number of optical fibers 985 may range from 2 to 40, although more optical fibers 985 may be attached. According to alternative embodiments, there is a single optical fiber 985 in the fiber array unit (FAU) 980. The optical fibers 985 may be optically coupled to the edge coupler 203a. In some embodiments, an index-matching adhesive is spread and then cured to secure the fiber array unit (FAU) 980 to the optical package 900. The refractive index of the index-matched adhesive may range between about 1.4 and 1.5.

By utilizing the methods and structures as described herein, co-packaged optical packages and supporting substrates can be designed for die warpage control. The methods and structures described herein employ an edge dam to form a keep out zone (KOZ) proximate to engagement of the fiber array unit (FAU) to the optical package, in which the keep out zone (KOZ) does not include underfill that is filling the space between the base of the optical package and the supporting substrate. By minimizing warpage of the co-packaged optical packages and supporting substrate, larger alignment window are provided for coupling the optical fiber of the fiber array unit to the edge coupler of the optical package.

In an embodiment, a method of manufacturing an optical device includes: forming connection bumps on a first side of a base surface of an optical package; forming a dam between a second side of the base surface of the optical package and the first side, the dam positioned to define a keep out zone between the dam and a coupler surface present on a sidewall of the optical package; bonding the optical package to a supporting substrate through the connection bumps; and applying an underfill material from the first side of the optical package to fill a space between the optical package, the connection bumps, and the supporting substrate, wherein the underfill material fills the space from the first side of the optical package to the dam and does not fill a keep out zone at a second side of the optical package.

In an embodiment, a method of manufacturing an optical device, the method comprising: forming a plurality of first metal structures on a first region of a base surface of a die and a second metal structure on a second region of the base surface of the die, wherein the second metal structure has a different shape compared to the at least the first metal structure, and the second metal structure has a bar-type shape;

bonding the die to a supporting substrate through the plurality of the first metal structures; and applying an underfill material between the base surface of the die and the supporting substrate, wherein in a cross-sectional view, the underfill material extends from a top surface of the supporting substrate to a sidewall of the die. In an embodiment, the method includes applying the underfill includes injecting the underfill into the first region in a direction towards the second region. In an embodiment, the underfill that is injected into the first region fills a space between the plurality of the first metal structures. In an embodiment, the second metal structure obstructs the underfill from filling the second region. In an embodiment, the plurality of the first metal structures have a height that is greater than a height of the second metal structures. In an embodiment, the die includes a first portion including active devices and a second portion including a waveguide. In an embodiment, a polymeric layer is on the base surface of the die in the first region, wherein the polymeric layer is not present in at least a portion of the second region of the die. In an embodiment, the second metal structure is a metal pillar having a continuous width that extends across an entirety of a width for the plurality of the first metal structures.

In another embodiment, an optical device comprising: a substrate; an optical package bonded to the substrate through a plurality of connectors formed on a base surface of the optical package, wherein the optical package comprises an optical die and an electronic die connected to the optical die, and the optical die comprises at least a waveguide and the electronic die comprises at least an active device; an underfill material disposed between the optical package and the substrate and surrounding the plurality of connectors, wherein the underfill material is disposed within a first region of the base surface and a second region of the optical package adjacent to the first region that is free of the underfill material; and a fiber array unit optically connected to the optical package. In an embodiment, the second region is adjacent to a coupling surface for the fiber array unit. In an embodiment, the second region that is free of the underfill material has a length ranging from 100 microns to 200 microns. In an embodiment, the optical device further includes a dam structure between first region that includes the underfill material and the second region that is free of the underfill material. In an embodiment, the dam structure has a pillar type geometry that extends across an entirety of a width of the plurality of connections that are located the first region. In an embodiment, the dam structure comprises copper.

In yet another embodiment, an optical device comprising a substrate; an optical package bonded to the substrate through a plurality of connectors formed on a base surface of the optical package, wherein the optical package comprises an optical die and an electronic die connected to the optical die, and the optical die comprises at least a waveguide and the electronic die comprises at least an active device; an underfill material disposed between the optical package and the substrate and surrounding the plurality of connectors, wherein a first end of the underfill material is located under the base surface of the optical package; and a fiber array unit optically connected to the optical package. In an embodiment, the optical package comprises a first sidewall and a second sidewall, wherein at least a portion of the first sidewall is covered by the underfill material, and the second sidewall is free of the underfill material. In an embodiment, the second sidewall is adjacent to the fiber array unit that is optically connected to the optical package, the second sidewall of the optical package is on an opposite side of the optical package than the first sidewall. In an embodiment, the plurality of connectors are present in a first region between the optical package and the substrate that is adjacent to the first sidewall that is filled with the underfill. In an embodiment, a portion of a second region between the optical package and the substrate that is adjacent to the second sidewall is free of the underfill. In an embodiment, a dam structure is present between the first region and the portion of the second region that is free of the underfill.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor package comprising:
a first package component comprising:
a polymer layer;
a plurality of conductive connectors arranged in an array of rows and columns in a plan view, wherein the plurality of conductive connectors extends through the polymer layer; and
a conductive structure between the plurality of conductive connectors and an outer sidewall of the polymer layer in a plan view, and wherein the conductive structure has a width that extends across the array of the plurality of conductive connectors in the plan view;
a second package component bonded to the first package component by the plurality of conductive connectors; and
an underfill between the first package component and the second package component.

2. The semiconductor package of claim 1, wherein the first package component comprises an electronic integrated circuit (EIC) bonded to a photonic integrated circuit (PIC), wherein the polymer layer is disposed on a bottom surface of the PIC, and wherein a portion of the bottom surface of the PIC is free of the polymer layer in the plan view.

3. The semiconductor package of claim 2, wherein the portion of the bottom surface of the PIC that is free of the polymer layer is on an opposing side of the conductive structure as the plurality of conductive connectors.

4. The semiconductor package of claim 2, wherein an edge coupler overlaps the portion of the bottom surface of the PIC that is free of the polymer layer in a cross-sectional view.

5. The semiconductor package of claim 2, wherein the portion of the bottom surface of the PIC that is free of the polymer layer is further free of the underfill.

6. The semiconductor package of claim 1, wherein the plurality of conductive connectors comprise a plurality of under bump metallurgy (UBM) features, and wherein the conductive structure has a same material composition as the plurality of UBM features.

7. The semiconductor package of claim 1, wherein the underfill extends from a bottom surface of the conductive structure to a top surface of the second package component.

8. The semiconductor package of claim 1, wherein a first sidewall of the underfill extends from a sidewall of the conductive structure to a top surface of the second package component.

9. The semiconductor package of claim 8, wherein a second sidewall of the underfill that is opposite to the first sidewall of the underfill extends higher than the first sidewall of the underfill in a cross-sectional view.

10. A package comprising:
a substrate;
an optical package bonded to the substrate through a plurality of connectors, wherein the plurality of connectors extend through a polymer material, and wherein the optical package comprises an optical die and an electronic die bonded to the optical die;
a fiber array unit optically connected to an edge coupler in the optical package, wherein a first sidewall of the optical package that faces the fiber array unit is laterally offset from a first sidewall of the polymer material that faces the fiber array unit; and
an underfill material disposed between the optical package and the substrate and surrounding the plurality of connectors.

11. The package of claim 10, wherein a first sidewall of the underfill material that faces the fiber array unit is laterally offset from the first sidewall of the optical package that faces the fiber array unit.

12. The package of claim 10 further comprising a dam structure, wherein the dam structure is disposed between the plurality of connectors and the first sidewall of the polymer material that faces the fiber array unit.

13. The package of claim 12, wherein the plurality of connectors is disposed in an array in a plan view, and wherein the dam structure spans a width of the array in the plan view.

14. The package of claim 12, wherein the dam structure extends through and protrudes from the polymer material.

15. The package of claim 10, wherein a bottom region of the optical package is free of the underfill material, wherein the bottom region extends from the first sidewall of the optical package that faces the fiber array unit to the first sidewall of the polymer material that faces the fiber array unit.

16. The package of claim 10, wherein a second sidewall of the optical package that is opposite to the fiber array unit is aligned with a second sidewall of the polymer material that is opposite to the fiber array unit.

17. A package comprising:
a substrate;
an optical package bonded to the substrate through a plurality of connectors on a base surface of the optical package;
an underfill material disposed between the optical package and the substrate and surrounding the plurality of connectors, wherein a first outer sidewall of the underfill material extends to a first outer sidewall of the optical package, and wherein a second outer sidewall of the underfill material is overlapped by the optical package; and
a fiber array unit optically connected to the optical package.

18. The package of claim 17 further comprising a dam structure between the second outer sidewall of the underfill material and the plurality of connectors.

19. The package of claim 18, wherein the plurality of connectors and the dam structure extend through a polymer material, wherein a region of the polymer material is free of the underfill material, and wherein the region of the polymer material is on an opposite side of the dam structure as the plurality of connectors.

20. The package of claim 17, wherein the first outer sidewall of the underfill material extends higher than the second outer sidewall of the underfill material.
